(19) United States
(12) Patent Application Publication
(10) Pub. No.: US 2022/0074028 A1
(43) Pub. Date: Mar. 10, 2022

(54) FORGED COMPONENT, METHOD FOR MANUFACTURING THE SAME, AND CONNECTING ROD

(71) Applicant: AICHI STEEL CORPORATION, Tokai-shi (JP)

(72) Inventors: Michinori FUKUYAMA, Kanagawa (JP); Takeyuki UENISHI, Aichi (JP)

(73) Assignee: AICHI STEEL CORPORATION, Tokai-shi (JP)

(21) Appl. No.: 17/422,954

(22) PCT Filed: Feb. 6, 2020
(86) PCT No.: PCT/JP2020/004570

§ 371 Date: Jul. 14, 2021

(30) Foreign Application Priority Data
Mar. 14, 2019 (JP) 2019-046809

(51) Int. Cl. C22C 38/00; C22C 38/24; C22C 38/04; C22C 38/02; C22C 38/60; C22C 38/06; C21D 9/52

(52) U.S. Cl. CPC C22C 38/002; C22C 38/24; C22C 38/04; C21D 9/525; C22C 38/60; C22C 38/06; C22C 38/02

(57) ABSTRACT

A forged component having a chemical composition including, by mass %, C: 0.30 to 0.45%, Si: 0.05 to 0.35%, Mn: 0.50 to 0.90%, P: 0.030% or less, S: 0.040 to 0.070%, Cr: 0.01 to 0.50%, Al: 0.001 to 0.050%, V: 0.25 to 0.35%, Ca: 0 to 0.0100%, N: 0.0150% or less, and the balance being Fe and unavoidable impurities, and satisfying Formulae 1 through 3. The: metal structure is a ferrite pearlite structure, and a ferrite area ratio is 30% or more; Vickers hardness is in the range of 320 to 380 HV; 0.2% yield strength is 800 MPa or more; a Charpy V-notch impact value is in the range of 15 to 25 J/cm²: and an unevenness of fracture surface (surface area/cross sectional area) of the Charpy test piece after fracture is in the range of 1.47 to 1.60.

### TECHNICAL FIELD

The present invention relates to a forged component, a method for manufacturing the same, and a connecting rod.

### BACKGROUND ART

The weight saving for the improvement in fuel consumption is required for a forged component, such as a connecting rod, used for motor vehicles. It is effective in weight saving to increase the strength of a steel material to reduce its thickness. However, an increase in the strength of steel generally leads to deterioration of machinability. For this reason, the development of steel that satisfies both increase in strength and maintaining machinability is desired.

Further, it has been investigated that when a set of components is formed by combining two components, the two components are first molded in a state where the two components are coupled, and then the coupled component is finally fracture-split to produce the two components. When this manufacturing method is employed, rationalization of a manufacturing process can be achieved, and assemblability of the two components after fracture splitting is improved. In order to make such manufacturing method possible, it is necessary to use a steel which can achieve fracture-splittability performance at least after hot forging thereof.

As an example of such steel that has achieved the high strength performance, machinability and easy fracture-splittability performance, Patent Document 1 discloses such improved steel.

### PRIOR ART LITERATURE

### Patent Documents

Patent Document 1: JP 5681333 B

### SUMMARY OF THE INVENTION

### Problems to be Solved by the Invention

The steel disclosed in Patent Document 1 is considered to keep high technical level in achievements in strength performance, machinability, and fracture-splittability performance, in view of the current technology. On the other hand, regarding the assemblability after the fracture split, further improvements are still needed. In other words, a demand has been increased that the contacting position of the separately formed two component parts, which have been split by fracture-splitting of forged component, must be surely aligned with the original position, upon re-assembling thereof integrally, by contacting at the respective fracture-split surfaces.

The present invention intends to provide, based on such a background, a forged component, a method for manufacturing the same, and a connecting rod that can achieve an improvement in three technical levels of performances which are high strength, machinability, and fracture-splittability and at the same time achieve an easy re-positioning of the split component parts at the fracture-split surfaces, i.e., achieve high assemblability.

### Means for Solving the Problems

One aspect of the present invention is a forged component having a chemical composition including, by mass %, C: 0.30 to 0.45%, Si: 0.05 to 0.35%, Mn: 0.50 to 0.90%, P: 0.030% or less, S: 0.040 to 0.070%, Cr: 0.01 to 0.50%, Al: 0.001 to 0.050%, V: 0.25 to 0.35%, Ca: 0 to 0.0100%, N: 0.0150% or less, and the balance being Fe and unavoidable impurities, and satisfying the following formulae 1, 2 and 3:

24<8×[C]+7×[Si]+10×[Mn]+220×[P]+45×[V]<33 Formula 1:

[C]−4×[S]+[V]−25×[Ca]<0.44, and Formula 2:

2.15≤4×[C]−[Si]+(⅕)×[Mn]+7×[Cr]−[V]≤2.61 Formula 3:

(wherein [X] in the Formulae 1 through 3 means a value of the content ratio (mass %) of an element X), wherein

metal structure is a ferrite pearlite structure, and a ferrite area ratio is 30% or more;

Vickers hardness is in the range of 320 to 380 HV;

0.2% yield strength is 800 MPa or more;

a Charpy V-notch impact value is in the range of 15 to 25 J/cm²; and

an unevenness of fracture surface (surface area/cross sectional area) of the Charpy test piece after fracture is in the range of 1.47 to 1.60.

### Effects of the Invention

The forged component has the above specific chemical composition and at the same time has the performance characteristics represented by the Vickers hardness, 0.2% yield strength and the Charpy impact value being in the specific ranges as specified above and further the forged component has the performance characteristics represented by the unevenness of fracture surface (surface area/cross sectional area) of the Charpy test piece after fracture being in the range of 1.47 to 1.60. Accordingly, the forged component is superior in machinability, keeping high strength performance and at the same time has achieved no defect or deformation by fracture-splitting. In other words, the forged component can achieve the improvements with high level in all three performances, high strength, machinability and improved fracture-splittability. In addition to these improvements, easier re-positioning of the split component parts at the fracture-split surfaces compared to the conventional method by defining the value of unevenness of the fractured surfaces to be within the specific range, thus achieving superior assemblability.

### BRIEF DESCRIPTION OF THE DRAWINGS

FIG. 1 is an explanatory view showing the relationship between the value obtained by the formula 1 and fracture surface unevenness according to Experimental Example 1.

FIG. 2 is an explanatory view showing the relationship between Charpy impact value and the fracture surface unevenness according to Experimental Example 1.

FIG. 3 is an explanatory view showing the relationship between the P-content ratio and the Charpy impact value according to Experimental Example 1.

FIG. 4 is an explanatory view showing the relationship between hardness and 0.2% yield strength according to Experimental Example 1.

FIG. 5 is an explanatory view showing the relationship between hardness and a machinability index according to Experimental Example 1.

FIG. 6 is an explanatory view showing the relationship between the value obtained by the formula 2 and the machinability according to Experimental Example 1.

FIG. 7 is an explanatory view showing the relationship between N-content ratio and 0.2% yield strength according to Experimental Example 2.

FIG. 8 is an explanatory view showing the relationship between the Charpy impact value and the fracture surface unevenness according to Experimental Example 2.

FIG. 9 is an explanatory view showing the relationship between the hardness and the Charpy impact value according to Experimental Example 3.

FIG. 10 is an explanatory view showing the relationship between 0.2% yield strength and the Charpy impact value according to Experimental Example 3.

FIG. 11 is an explanatory view showing the unevenness of test piece E1 according to Experimental Example 1.

FIG. 12 is an explanatory view showing the unevenness of test piece C1 according to Experimental Example 1.

### MODES FOR CARRYING OUT THE INVENTION

The reason why the chemical composition in the above forged component is limited to the above values will be described hereinafter.

### C: 0.30 to 0.45%:

C (carbon) is a basic element for securing strength. To obtain proper strength, hardness, and Charpy impact value and to secure proper machinability, it is important to set C-content ratio in the above range. When C-content ratio is less than the lower limit, it is difficult to secure strength and the like, and a deformation may occur during fracture splitting. When C-content ratio exceeds the upper limit, there may be problems such as deterioration of machinability and chipping during fracture splitting. Note that to obtain a tensile strength of more than 1100 MPa, Carbon is preferably contained in an amount of 0.35% or more.

### Si: 0.05 to 0.35%,

Si (silicon) is an element which is not only effective as a deoxidizer during steel manufacture but also effective for improvement in strength and fracture splittability. To obtain these effects, Si needs to be added in an amount of the lower limit or more and preferably to be added in an amount of 0.10% or more. On the other hand, when Si content ratio is too high, decarbonization may increase, and an adverse influence may occur in fatigue strength. Therefore, Si content ratio is set to the upper limit or less.

### Mn: 0.50 to 0.90%:

Mn (manganese) is an element effective for deoxidation during steel manufacture and for adjusting the strength and toughness balance of steel. To optimize metal structure and improve machinability and fracture splittability in addition to the adjustment of strength and toughness balance, it is necessary to set Mn-content ratio within the above range. When Mn-content ratio is less than the lower limit, deterioration of strength and deformation during fracture splitting may occur. When Mn-content ratio exceeds the upper limit, machinability may be deteriorated by an increase in perlite or precipitation of bainite.

### P: 0.030% or Less:

P (phosphorus) is an element which affects fracture splittability. Therefore, by limiting P-content ratio to the above range, the fracture surface unevenness (surface area/cross sectional area) of the Charpy test piece after fracture can be set within a proper range, which can result in an easy re-positioning of the fracture-spilt surfaces to the original position, easier than conventional way.

### S: 0.040 to 0.070%:

S (sulfur) is an element effective for improving machinability. To obtain this effect, S is contained in an amount equal to the lower limit or more. On the other hand, since a crack is likely to occur during forging when S-content ratio is too high, S-content ratio is limited to the upper limit or less.

### Cr: 0.01 to 0.50%:

Since Cr (chromium) is an element effective for adjusting the strength and toughness balance of steel like Mn, Cr is added in an amount equal to the lower limit or more. On the other hand, when Cr-content ratio is increased to an excessively high level, machinability may be deteriorated by an increase in perlite or precipitation of bainite in the same manner as in the case of Mn. Therefore, Cr-content ratio is limited to the upper limit or less.

### Al: 0.001 to 0.050%:

Since Al (aluminum) is an element effective for deoxidation treatment, Al is added in an amount equal to the lower limit or more. On the other hand, since an increase of Al content may cause deterioration of machinability due to an increase in an alumina-based inclusion, Al-content ratio is limited to the upper limit or less.

### V: 0.25 to 0.35%:

V (vanadium) is an element which is finely precipitated in ferrite as carbonitride during cooling after hot forging and improves strength by precipitation strengthening. Therefore, V is added in an amount equal to the lower limit or more. On the other hand, since V greatly influences cost, V-content ratio is limited to the upper limit or less.

### Ca: 0 to 0.0100% (Including the Case of 0%):

Since Ca (calcium) is effective for improving machinability, Ca can be optionally added. When Ca is not substantially contained, machinability improvement effect by Ca, accordingly, cannot be expected. However, the necessary machinability can be secured if formula 1 is satisfied. Therefore, Ca is not an essential element but an optional element. On the other hand, since the machinability improvement effect by adding Ca is saturated when the amount of Ca added reaches to a higher point, the amount of Ca added is limited to the above specified upper limit or less.

### N: 0.0150% or Less,

N (nitrogen) is an element which is contained in the largest amount in air, and N is inevitably contained as an impurity when manufacturing is performed by melting in air. However, if N-content ratio exceeds the upper limit, N is combined with V in steel to form a large amount of relatively large carbonitride which does not contribute to strength improvement and may suppress the strength improvement effect by adding V. Therefore, N-content ratio is limited to the upper limit or less. Note that even when N-content ratio is within the above range, relatively coarse carbonitride which does not contribute to strength improvement may increase in steel as N content ratio increases. To avoid this phenomenon to secure the strength after forging, it is preferred to heat steel to a higher temperature during hot forging to dissolve the relatively coarse carbonitride.

As shown also in Table 1 to be described below, examples of unavoidable impurities in the above chemical composition include Cu, Ni, and Mo, etc.

In addition to limiting the ratio content range of each element as described above, the above chemical composition further needs to satisfy all of the formulae 1, 2 and 3.

In this invention, as will be described later, the fracture-splittability is evaluated by the condition of the fracture surface unevenness obtained by fracturing of the Charpy impact test piece. The formula 1 indicates a condition necessary for determining the proper range of the fracture surface unevenness (surface area/cross sectional area) by fracture-splitting of the Charpy impact test piece. If the formula 1 is not satisfied, the mechanical characteristic that controls the fracture surface unevenness of the Charpy impact value, etc., to properly determine the range of the value thereof may be deviated from the optimal range and in such case, it becomes difficult to control the fracture surface unevenness (surface area/cross sectional area) to the proper range.

[C]−4×[S]+[V]−25×[Ca]<0.44. Formula 2:

Satisfying the formula 2 is the necessary condition for securing the superior machinability regardless of containing of Ca. In more concrete, a forged component having ferrite area ratio being 30% or more, Vickers hardness being in the range of 380 HV or less and further satisfying the formula 2 can secure the machinability with no manufacturing problem, regardless of containing of Ca, although having relatively high hardness as a hot forging component.

2.15≤4×[C]−[Si]+(⅕)×[Mn]+7×[Cr]−[V]≤2.61 Formula 3:

The formula 3 is the necessary condition to achieve 30% or more ferrite area ratio for a steel according to the present invention having the above defined composition range. If the formula 3 is not satisfied, the ferrite area ratio may be less than 30%. Although it may not always become less than 30% when the formula 3 is not satisfied, by determining the optimal composition as defined in the formula 3, the 30% or more ferrite area ratio can be further securely obtained.

The forged component according to the present invention has the following properties.

The metal structure is a ferrite pearlite structure, and the ferrite area ratio is 30% or more. This can raise the yield ratio and at the same time improve the machinability.

The Vickers hardness is in the range of 320 to 380 HV. It is necessary to have the Vickers hardness in the range of 320 HV or more to secure the later explained 0.2% yield strength. On the other hand, to secure the machinability, it is necessary to have the Vickers hardness in the range of 380 HV or less.

The 0.2% yield strength is set to be 800 MPa or more. By securing this performance, weight reduction by high strengthening of the material can be achieved.

The Charpy V-notch impact value is in the range of 15 to 25 J/cm². When the above Charpy impact value is too low, the fracture surface becomes too flat, and the value of fracture surface unevenness (surface area/cross sectional area) may become too small. On the other hand, when the impact value is too high, larger deformation may occur by fracture-splitting, which may change the shape of the component after assembling. Thus, the assembled component may lose function as a product.

The unevenness of fracture surface (surface area/cross sectional area) of the Charpy test piece after fracture is set to be in the range of 1.47 to 1.60. If the unevenness value of the fracture surface is below the above specified range, the fracture surface becomes too flat to secure the easiness of re-positioning of the component parts at the fracture-split surfaces (assemblability). On the other hand, if the unevenness value is above the value of the above specified range, the deformation of the fracture surface becomes too large to function as the assembled component as explained above.

The forged component having the above excellent properties can be applicable to various members. Particularly, a manufacturing method utilizing fracture splitting can be applied to a connecting rod, and the above steel is highly effectively applied to the connecting rod.

Further, in manufacturing the above forged component, at least the following steps are performed: a step of melting a raw material in an electric furnace or the like to produce a cast piece having the above specific chemical component and a step of subjecting the cast piece to hot working such as hot rolling to prepare a steel material for forging; a step of subjecting the steel material for forging to hot forging; and a step of cooling for cooling the forged product after hot forging.

In more detail, a forged component is produced by the step of hot forging a steel material having the above specific chemical component, under the forging temperature of 1230° C. to 1300° C. By setting the forging temperature to this specific range, V-carbonitride which is relatively coarse in the steel material can be dissolved by heating at the hot forging. Thus, a fine V-carbonitride which contributes to the improvement in strength can be precipitated at the cooling step to be able to obtain intended mechanical properties such as yield strength. On the other hand, when the forging is made by the forging temperature of less than 1230° C., the amount of dissolved coarse V-carbonitride is reduced and a fine V-carbonitride, which is to be obtained by cooling, may be also reduced. And thus, it may become difficult to secure the yield strength of 800 MPa or more. On the other hand, in the case of exceeding 1300° C., decarbonization and/or generation of scales may cause deterioration of the surface properties, and which may result in reduction of the function as a component.

After the hot forging, the cooling step is performed so that the average cooling speed for cooling from 800 to 600° C. is set to be in the range of 150 to 250° C./min. The reason why the lower limit of the average cooling speed is set to 150° C./min is, that, if the cooling speed is slower than the lower limit, it will be difficult to achieve a targeted high strength, hardness, and impact value. Further, the reason why the upper limit of the average cooling speed is set to 250° C./min is that, if the cooling speed is higher than the upper limit, a bainite structure may be produced and such bainite structure may prevent achievement of targeted mechanical properties. The reason why the range of the cooling speed is set to be in the temperature range of 800 to 600° C. is that the cooling speed in this temperature range most greatly influences on mechanical properties.

### EXAMPLES

### Experimental Example 1

As shown in Table 1, plural types of samples each having a different chemical composition were prepared in this experimental example, and these samples were subjected to processing, assuming the case where a connecting rod is produced. In Table 1, the samples E1 through E21 were test pieces prepared by the composition according to this invention and these test pieces satisfy all conditions of the above three formulae 1 through 3. The samples C1 through C16 are comparative test pieces which do not satisfy a part of the compositions of the invention and do not satisfy at least one of the three formulae 1 through 3. It is noted that the manufacturing method of respective samples can be changed to any existing method. Further, the elements Cu, Ni, and Mo shown in Table 1 are unavoidably contained as the impurities in the case of manufacturing by dissolving scraps although they were not positively intended to be added as necessary chemical components, therefore, the analytical values of these elements are shown in Table 1. In addition, the analytical value of the element Ca is also shown in Table 1, including the case where Ca was not positively intended to be added but was contained as the impurity.

TABLE 1

| Sample | | Chemical Composition (By mass %) | | | | | | | | | | |
|---|---|---|---|---|---|---|---|---|---|---|---|---|
| No. | | C | Si | Mn | P | S | Cu | Ni | Cr | Mo | Al | V |
| Example | E1 | 0.36 | 0.34 | 0.69 | 0.015 | 0.060 | 0.10 | 0.05 | 0.21 | 0.022 | 0.007 | 0.32 |
| | E2 | 0.30 | 0.25 | 0.75 | 0.020 | 0.060 | 0.10 | 0.05 | 0.20 | 0.025 | 0.008 | 0.31 |
| | E3 | 0.31 | 0.22 | 0.75 | 0.017 | 0.054 | 0.09 | 0.06 | 0.19 | 0.027 | 0.008 | 0.34 |
| | E4 | 0.33 | 0.24 | 0.74 | 0.019 | 0.059 | 0.10 | 0.05 | 0.18 | 0.022 | 0.005 | 0.30 |
| | E5 | 0.31 | 0.22 | 0.68 | 0.025 | 0.057 | 0.10 | 0.05 | 0.20 | 0.021 | 0.007 | 0.33 |
| | E6 | 0.37 | 0.08 | 0.72 | 0.014 | 0.062 | 0.10 | 0.04 | 0.19 | 0.027 | 0.009 | 0.32 |
| | E7 | 0.40 | 0.15 | 0.65 | 0.020 | 0.055 | 0.10 | 0.05 | 0.15 | 0.028 | 0.003 | 0.26 |
| | E8 | 0.38 | 0.23 | 0.87 | 0.030 | 0.061 | 0.10 | 0.05 | 0.20 | 0.028 | 0.003 | 0.26 |
| | E9 | 0.44 | 0.16 | 0.55 | 0.010 | 0.065 | 0.11 | 0.05 | 0.16 | 0.042 | 0.007 | 0.26 |
| | E10 | 0.32 | 0.30 | 0.73 | 0.029 | 0.059 | 0.09 | 0.04 | 0.20 | 0.024 | 0.008 | 0.32 |
| | E11 | 0.30 | 0.28 | 0.85 | 0.018 | 0.068 | 0.10 | 0.05 | 0.21 | 0.022 | 0.007 | 0.34 |
| | E12 | 0.33 | 0.34 | 0.55 | 0.009 | 0.049 | 0.11 | 0.06 | 0.21 | 0.026 | 0.007 | 0.30 |
| | E13 | 0.36 | 0.23 | 0.85 | 0.021 | 0.059 | 0.10 | 0.05 | 0.18 | 0.023 | 0.008 | 0.26 |
| | E14 | 0.38 | 0.23 | 0.71 | 0.015 | 0.055 | 0.10 | 0.04 | 0.19 | 0.025 | 0.005 | 0.27 |
| | E15 | 0.34 | 0.25 | 0.77 | 0.018 | 0.058 | 0.09 | 0.05 | 0.22 | 0.030 | 0.010 | 0.32 |
| | E16 | 0.42 | 0.17 | 0.65 | 0.025 | 0.050 | 0.10 | 0.05 | 0.14 | 0.031 | 0.003 | 0.27 |
| | E17 | 0.32 | 0.20 | 0.77 | 0.026 | 0.054 | 0.09 | 0.05 | 0.19 | 0.027 | 0.008 | 0.34 |
| | E18 | 0.38 | 0.34 | 0.52 | 0.019 | 0.050 | 0.12 | 0.04 | 0.20 | 0.021 | 0.006 | 0.30 |
| | E19 | 0.35 | 0.29 | 0.67 | 0.022 | 0.059 | 0.10 | 0.04 | 0.23 | 0.019 | 0.005 | 0.32 |
| | E20 | 0.39 | 0.15 | 0.65 | 0.021 | 0.056 | 0.11 | 0.05 | 0.15 | 0.025 | 0.045 | 0.26 |
| | E21 | 0.33 | 0.33 | 0.57 | 0.010 | 0.048 | 0.11 | 0.06 | 0.20 | 0.026 | 0.033 | 0.30 |
| Comparative | C1 | 0.36 | 0.25 | 0.70 | 0.044 | 0.064 | 0.16 | 0.05 | 0.21 | 0.051 | 0.003 | 0.30 |
| Example | C2 | 0.45 | 0.25 | 0.71 | 0.015 | 0.056 | 0.10 | 0.05 | 0.20 | 0.020 | 0.007 | 0.46 |
| | C3 | 0.32 | 0.61 | 1.02 | 0.017 | 0.059 | 0.21 | 0.21 | 0.21 | 0.050 | 0.020 | 0.30 |
| | C4 | 0.21 | 0.61 | 1.02 | 0.016 | 0.059 | 0.21 | 0.21 | 0.21 | 0.050 | 0.022 | 0.30 |
| | C5 | 0.32 | 0.70 | 1.19 | 0.071 | 0.049 | 0.02 | 0.01 | 0.22 | 0.010 | 0.028 | 0.25 |
| | C6 | 0.35 | 0.81 | 0.56 | 0.021 | 0.053 | 0.19 | 0.09 | 0.19 | 0.110 | 0.033 | 0.37 |
| | C7 | 0.33 | 0.70 | 1.20 | 0.070 | 0.051 | 0.05 | 0.09 | 0.20 | 0.010 | 0.030 | 0.25 |
| | C8 | 0.37 | 0.25 | 0.75 | 0.010 | 0.055 | 0.11 | 0.06 | 0.20 | 0.032 | 0.012 | 0.20 |
| | C9 | 0.51 | 0.29 | 0.74 | 0.010 | 0.042 | 0.01 | 0.04 | 0.19 | 0.030 | 0.011 | 0.07 |
| | C10 | 0.34 | 0.24 | 0.70 | 0.017 | 0.058 | 0.10 | 0.05 | 0.19 | 0.029 | 0.009 | 0.32 |
| | C11 | 0.37 | 0.25 | 0.69 | 0.015 | 0.053 | 0.10 | 0.05 | 0.19 | 0.035 | 0.008 | 0.28 |
| | C12 | 0.30 | 0.20 | 0.55 | 0.011 | 0.055 | 0.13 | 0.08 | 0.20 | 0.027 | 0.010 | 0.27 |
| | C13 | 0.37 | 0.40 | 0.50 | 0.006 | 0.060 | 0.10 | 0.06 | 0.20 | 0.030 | 0.008 | 0.26 |
| | C14 | 0.32 | 0.30 | 0.60 | 0.007 | 0.059 | 0.10 | 0.05 | 0.25 | 0.024 | 0.015 | 0.25 |
| | C15 | 0.44 | 0.22 | 0.58 | 0.006 | 0.064 | 0.11 | 0.04 | 0.13 | 0.022 | 0.006 | 0.25 |
| | C16 | 0.39 | 0.15 | 0.60 | 0.005 | 0.063 | 0.10 | 0.05 | 0.15 | 0.042 | 0.008 | 0.28 |

| Sample | | Chemical Composition (By mass %) | | | | | |
|---|---|---|---|---|---|---|---|
| No. | | Ca | N | Fe | Formula 1 | Formula 2 | Formula 3 |
| Example | E1 | 0.0001 | 0.0074 | bal. | 29.9 | 0.438 | 2.39 |
| | E2 | 0.0002 | 0.0060 | bal. | 30.0 | 0.365 | 2.19 |
| | E3 | 0.0002 | 0.0068 | bal. | 30.6 | 0.429 | 2.16 |
| | E4 | 0.0001 | 0.0058 | bal. | 29.4 | 0.392 | 2.19 |
| | E5 | 0.0002 | 0.0055 | bal. | 30.8 | 0.402 | 2.23 |
| | E6 | 0.0002 | 0.0065 | bal. | 28.2 | 0.437 | 2.55 |
| | E7 | 0.0002 | 0.0054 | bal. | 26.9 | 0.435 | 2.37 |
| | E8 | 0.0002 | 0.0071 | bal. | 31.7 | 0.391 | 2.60 |
| | E9 | 0.0002 | 0.0067 | bal. | 24.0 | 0.435 | 2.57 |
| | E10 | 0.0002 | 0.0070 | bal. | 32.7 | 0.399 | 2.21 |
| | E11 | 0.0001 | 0.0063 | bal. | 32.1 | 0.366 | 2.22 |
| | E12 | 0.0002 | 0.0054 | bal. | 26.0 | 0.429 | 2.26 |
| | E13 | 0.0002 | 0.0070 | bal. | 29.5 | 0.383 | 2.38 |
| | E14 | 0.0014 | 0.0145 | bal. | 27.2 | 0.395 | 2.49 |
| | E15 | 0.0031 | 0.0120 | bal. | 30.5 | 0.351 | 2.48 |
| | E16 | 0.0021 | 0.0054 | bal. | 28.7 | 0.438 | 2.35 |
| | E17 | 0.0013 | 0.0068 | bal. | 32.7 | 0.412 | 2.22 |
| | E18 | 0.0025 | 0.0056 | bal. | 28.3 | 0.418 | 2.38 |
| | E19 | 0.0005 | 0.0066 | bal. | 30.8 | 0.422 | 2.53 |
| | E20 | 0.0002 | 0.0060 | bal. | 27.0 | 0.421 | 2.33 |
| | E21 | 0.0001 | 0.0057 | bal. | 26.4 | 0.436 | 2.20 |
| Comparative | C1 | 0.0003 | 0.0066 | bal. | 34.8 | 0.397 | 2.50 |
| Example | C2 | 0.0002 | 0.0084 | bal. | 36.5 | 0.681 | 2.63 |
| | C3 | 0.0003 | 0.0085 | bal. | 34.3 | 0.377 | 2.04 |
| | C4 | 0.0001 | 0.0077 | bal. | 33.2 | 0.272 | 1.61 |
| | C5 | 0.0003 | 0.0058 | bal. | 46.2 | 0.367 | 2.11 |
| | C6 | 0.0002 | 0.0074 | bal. | 35.3 | 0.503 | 1.66 |
| | C7 | 0.0002 | 0.0127 | bal. | 46.2 | 0.371 | 2.01 |
| | C8 | 0.0003 | 0.0086 | bal. | 23.4 | 0.343 | 2.58 |
| | C9 | 0.0001 | 0.0014 | bal. | 18.9 | 0.410 | 3.16 |
| | C10 | 0.0016 | 0.0158 | bal. | 29.5 | 0.388 | 2.27 |
| | C11 | 0.0028 | 0.0165 | bal. | 27.5 | 0.368 | 2.42 |
| | C12 | 0.0003 | 0.0088 | bal. | 23.9 | 0.343 | 2.24 |
| | C13 | 0.0002 | 0.0070 | bal. | 23.8 | 0.385 | 2.32 |
| | C14 | 0.0005 | 0.0065 | bal. | 23.5 | 0.322 | 2.60 |
| | C15 | 0.0002 | 0.0078 | bal. | 23.4 | 0.429 | 2.32 |
| | C16 | 0.0001 | 0.0077 | bal. | 23.9 | 0.416 | 2.30 |

### <Strength Evaluation Test, Etc.>

A test piece for strength evaluation was prepared as follows. A cast piece produced by melting in an electric furnace was subjected to hot rolling to prepare a bar steel. The bar steel was subjected to extend forging to produce a round bar having a diameter of 20 mm as a steel material for forging. Subsequently, the round bar was heated to 1230° C. corresponding to a treatment temperature in actual hot forging and held at this temperature for 30 minutes. The heated round bar was then cooled by fan cooling to room temperature under the condition that the average cooling speed from 800 to 600° C. is about 190° C./min.

The evaluation using the test piece for strength evaluation was performed on the following items.

Measurement of hardness: Vickers hardness was measured according to JIS Z 2244.

Measurement of tensile strength and 0.2% yield strength: The tensile strength and 0.2% yield strength were determined by performing a tensile test according to JIS Z 2241.

Ferrite area ratio: A section of a test piece was subjected to Nital corrosion and then observed with an optical microscope. The area ratio was determined by point counting according to JIS G0551.

Charpy impact value: The Charpy impact value was determined by performing the Charpy V-notch impact test according to JIS Z 2242.

Fracture surface unevenness: The fracture surface of the Charpy impact test piece was measured, using 3-D (three dimensional) non-contact shape measurement device, and the area ratio between the surface area (surface area considering the unevenness of the fracture surface) and the cross-sectional surface (assumed to be flat, not considering the unevenness of the fracture surface) was calculated.

The above 3-D non-contact shape measurement device is the device which obtains the three-dimensional information by using a so-called light cutting method wherein a striped light is irradiated on an object to be measured and forms and measures image of light which is a bent light bending in accordance with the shape of odd-shaped surface from a different angle direction. It is noted that the three-dimensional non-contact measurement device is substituted for a device using a laser light. However, the measurement method using the light cutting method can take images more widely in a short time than the measurement using the laser light.

The metal structure was determined to be acceptable when the structure is a ferrite pearlite structure, and a ferrite area ratio was 30% or more and the structure other than the above condition was determined to be not acceptable. When Vickers hardness was in the range of 320 to 380 HV, hardness was determined to be acceptable, and the hardness other than the above range was determined to be not acceptable. When 0.2% yield strength was 800 MPa or more, 0.2% yield strength was determined to be acceptable, and the 0.2% yield strength other than the above range was determined to be not acceptable. When a Charpy V-notch impact value was in the range of 15 to 25 J/cm², the Charpy V-notch impact value was determined to be acceptable, and the Charpy V-notch impact value other than the above range was determined to be not acceptable. The fracture surface unevenness (surface area/cross sectional area) is determined to be acceptable when the value was in the range of 1.47 to 1.60 and the unevenness other than the above range was determined to be not acceptable. It is noted that the relationship between the fracture surface unevenness and the assemblability etc., will be explained later in the column of “Influence of fracture surface unevenness.”

### <Machinability Evaluation Test>

A test piece for machinability evaluation was prepared as follows. A cast piece produced by melting in an electric furnace was subjected to hot rolling to prepare a bar steel. The bar steel was subjected to extend forging to produce a square bar having a square cross section 25 mm on a side as a steel material for forging. Subsequently, the square bar was heated to 1230° C. corresponding to a treatment temperature of actual hot forging and held at this temperature for 30 minutes. The heated square bar was then cooled by fan cooling to room temperature under the condition that the average cooling speed from 800 to 600° C. is about 190° C./min. The cooled square bar was machined into a square bar having a square cross section 20 mm on a side, which was used as a test piece for machinability evaluation.

The machinability test was performed by drilling with a drill. The test conditions are as follows.

The drill used: a high-speed steel drill having a diameter of 8 mm

Drill number of revolutions: 800 rpm

Feed: 0.20 mm/rev

Machining depth: 11 mm

The number of machined holes: 300 holes (not cut through)

Measurement of a drill abrasion loss was performed in a flank corner part of the drill after machining 300 holes.

The machinability index was calculated by setting the drill abrasion loss of a reference material to 1 and obtaining the ratio of the drill abrasion loss of each sample to that of the reference material. As the reference material was used conventional JIS carbon steel for machinery (hardness: 250 HV) having a chemical composition of C: 0.23%, Si: 0.25%, Mn: 0.80%, Cr: 0.20%, and the balance being Fe and unavoidable impurities. This conventional steel was used as a reference material because this conventional steel had a significantly low hardness as compared with the steel according to the present application and had satisfactory machinability in manufacturing even if an element for improving machinability such as S is not added. Then, when the machinability index was 1.20 or less, machinability was determined to be acceptable because there was no problem found in machining after forging process, and when the machinability index exceeded 1.20, machinability was determined to be not acceptable.

Each evaluation result is shown in Table 2.

TABLE 2

| | | | Tensile | 0.2% Yield | | | Charpy | Fracture | |
|---|---|---|---|---|---|---|---|---|---|
| Sample | | Hardness | Strength | Strength | Yield | Ferrite | Impact Value | Surface | Machinability |
| No. | | HV | MPa | MPa | Ratio | Area Ratio | J/cm² | Unevenness | Index |
| Example | E1 | 324 | 1033 | 820 | 0.794 | 65% | 18.7 | 1.54 | 1.11 |
| | E2 | 333 | 1130 | 907 | 0.803 | 73% | 17.2 | 1.53 | 1.02 |
| | E3 | 339 | 1105 | 872 | 0.789 | 69% | 15.6 | 1.53 | 0.95 |
| | E4 | 334 | 1070 | 860 | 0.804 | 58% | 15.9 | 1.56 | 1.04 |
| | E5 | 328 | 1048 | 827 | 0.789 | 68% | 17.5 | 1.49 | 1.00 |
| | E6 | 341 | 1177 | 927 | 0.788 | 30% | 16.5 | 1.52 | 1.10 |
| | E7 | 340 | 1156 | 905 | 0.783 | 33% | 17.7 | 1.55 | 1.07 |
| | E8 | 335 | 1148 | 913 | 0.795 | 30% | 18.1 | 1.58 | 1.01 |
| | E9 | 325 | 1024 | 815 | 0.796 | 31% | 15.4 | 1.54 | 1.15 |
| | E10 | 333 | 1113 | 844 | 0.758 | 43% | 16.5 | 1.50 | 1.09 |
| | E11 | 331 | 1122 | 846 | 0.754 | 51% | 18.5 | 1.55 | 0.95 |
| | E12 | 322 | 1073 | 830 | 0.774 | 45% | 20.6 | 1.52 | 1.10 |
| | E13 | 325 | 1065 | 821 | 0.771 | 56% | 20.9 | 1.59 | 1.03 |
| | E14 | 329 | 1070 | 805 | 0.752 | 35% | 23.4 | 1.59 | 1.05 |
| | E15 | 336 | 1092 | 817 | 0.748 | 45% | 17.2 | 1.52 | 1.02 |
| | E16 | 370 | 1260 | 968 | 0.768 | 33% | 15.7 | 1.51 | 1.15 |
| | E17 | 356 | 1109 | 866 | 0.781 | 69% | 17.0 | 1.53 | 0.98 |
| | E18 | 353 | 1132 | 899 | 0.794 | 39% | 16.1 | 1.53 | 0.99 |
| | E19 | 365 | 1168 | 932 | 0.798 | 54% | 16.8 | 1.52 | 1.19 |
| | E20 | 338 | 1160 | 894 | 0.771 | 33% | 17.7 | 1.55 | 1.07 |
| | E21 | 323 | 1068 | 829 | 0.776 | 46% | 20.6 | 1.52 | 1.10 |
| Comparative | C1 | 342 | 1119 | 844 | 0.754 | 62% | 12.9 | 1.39 | 1.07 |
| Example | C2 | 392 | 1249 | 998 | 0.799 | 41% | 8.8 | 1.42 | 1.82 |
| | C3 | 312 | 1050 | 840 | 0.800 | 60% | 4.0 | 1.40 | 1.05 |
| | C4 | 282 | 950 | 740 | 0.779 | 60% | 5.0 | 1.43 | 0.81 |
| | C5 | 333 | 1075 | 871 | 0.810 | 15% | 10.9 | 1.41 | 1.45 |
| | C6 | 351 | 1162 | 906 | 0.780 | 24% | 10.4 | 1.35 | 1.39 |
| | C7 | 333 | 1063 | 876 | 0.824 | 10% | 9.0 | 1.42 | 1.50 |
| | C8 | 301 | 975 | 698 | 0.716 | 44% | 27.8 | 1.62 | 0.97 |
| | C9 | 241 | 875 | 516 | 0.590 | 13% | 39.3 | 1.91 | 1.13 |
| | C10 | 328 | 1065 | 778 | 0.731 | 50% | 21.1 | 1.58 | 0.98 |
| | C11 | 330 | 1060 | 784 | 0.740 | 41% | 22.8 | 1.56 | 1.01 |
| | C12 | 293 | 960 | 671 | 0.699 | 52% | 26.3 | 1.65 | 0.94 |
| | C13 | 320 | 1040 | 775 | 0.745 | 45% | 28.6 | 1.63 | 0.97 |
| | C14 | 285 | 935 | 672 | 0.719 | 53% | 32.2 | 1.68 | 0.92 |
| | C15 | 370 | 1208 | 916 | 0.758 | 32% | 26.1 | 1.66 | 1.08 |
| | C16 | 345 | 1150 | 859 | 0.747 | 43% | 27.5 | 1.63 | 1.10 |

Table 2 reveals that the samples E1 to E21 provide good results for all the evaluation items and are considered to exert excellent properties in strength, machinability, Charpy impact value (fracture-splittability) and fracture surface unevenness.

On the other hand, the sample C1 had P-content ratio too high to satisfy the formula 1 and the Charpy impact value and the fracture surface unevenness were too low.

The sample C2 had V-content ratio too high to satisfy the formulae 1 and 2 and the hardness becomes too high, the machinability becomes worse and the Charpy impact value and the fracture surface unevenness were too low.

The sample C3 had Si and Mn-content ratios too high to satisfy the formula 1 and the hardness was too low and the Charpy impact value and the fracture surface unevenness were too low.

The sample C4 had C-content ratio too low and Si and Mn-content ratios too high to satisfy the formula 1 and the hardness and the 0.2% yield strength were too low and the Charpy impact value and the fracture surface unevenness were also too low.

The sample C5 had Si-content ratio, Mn-content ratio, and P-content ratio too high to satisfy the formulae 1 and 3. The ferrite area ratio was too low, and the machinability was deteriorated and the Charpy impact value and the fracture surface unevenness were also too low.

The sample C6 had Si-content ratio and V-content ratio too high to satisfy any of three formulae 1 through 3. The ferrite area ratio was too low, and the machinability was deteriorated and the Charpy impact value and the fracture surface unevenness were also too low.

The sample C7 had Si content ratio, Mn-content ratio and P-content ratio too high to satisfy the formulae 1 and 3. The ferrite area ratio was too low, and the machinability was deteriorated and the Charpy impact value and the fracture surface unevenness were also too low.

The sample C8 had V-content ratio too low to satisfy the formula 1 and the hardness and the 0.2% yield strength were too low and the Charpy impact value and the fracture surface unevenness were too high.

The sample C9 had high C-content ratio and the V-content ratio was too low to satisfy the formulae 1 and 3. The ferrite area ratio was too low, and the hardness and the 0.2% yield strength were too low and the Charpy impact value and the fracture surface unevenness were too high.

The samples C10 and C11 had too high N-content ratio and too low 0.2% yield strength.

Respective chemical components of the sample C12 were within each range defined in the present invention, but since the sample C12 did not satisfy the formula 1, the hardness and 0.2% yield strength were too low and the Charpy impact value and the fracture surface unevenness were too high.

The sample C13 had too high Si-content ratio to satisfy the formula 1 and 0.2% yield strength was too low and the Charpy impact value and the fracture surface unevenness were too high.

Respective chemical components of the samples C14 through C16 were within each range defined in the present invention. Since the samples C14 through C16 did not satisfy the formula 1, the hardness and 0.2% yield strength of the sample C14 were too low and the Charpy impact value and the fracture surface unevenness of the samples C14 through C16 were too high.

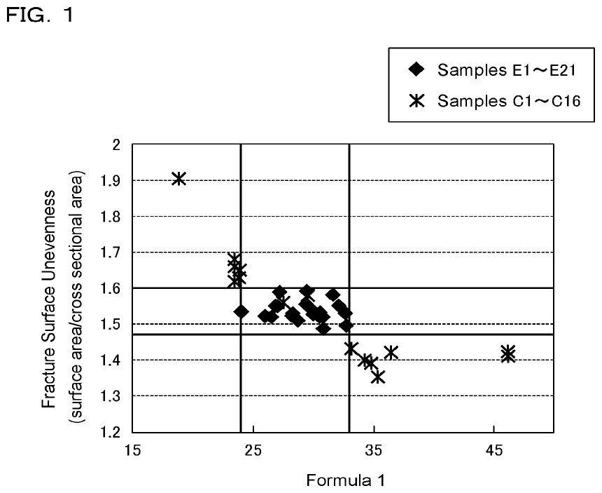

In FIG. 1, the horizontal axis indicates the values obtained by the formula 1 and the vertical axis indicates the fracture surface unevenness to show the relationship therebetween by plotting all experimental results. As shown in FIG. 1, it is important to at least satisfy the condition of the formula 1 to set the values of the fracture surface unevenness to be in the proper range.

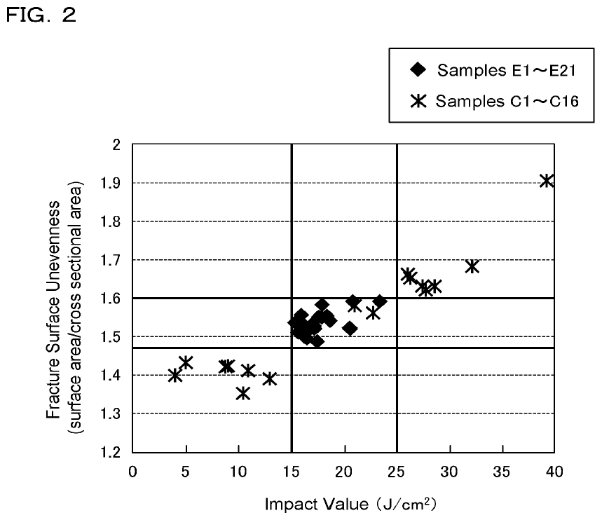

In FIG. 2, the horizontal axis indicates the Charpy impact value (J/cm²), and the vertical axis indicates the fracture surface unevenness to show the relationship therebetween by plotting all experimental results. As shown in FIG. 2, it is important to control the Charpy impact values to be in the range of 15 to 25 J/cm² to set the values of the fracture surface unevenness to be in the proper range.

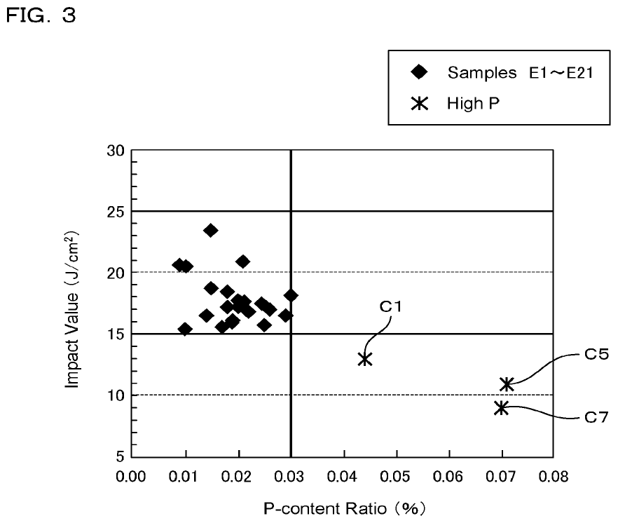

In FIG. 3, the horizontal axis indicates the P-content ratio (%) and the vertical axis indicates the Charpy impact value (J/cm²) and plotted the results of the samples E1 through E21, samples C1, C5 and C7 which had higher P-content ratio. As shown in FIG. 3, it is necessary to control the P-content ratio at least to be the ratio of 0.03% or less to set the Charpy impact value (J/cm²) to be in the proper range.

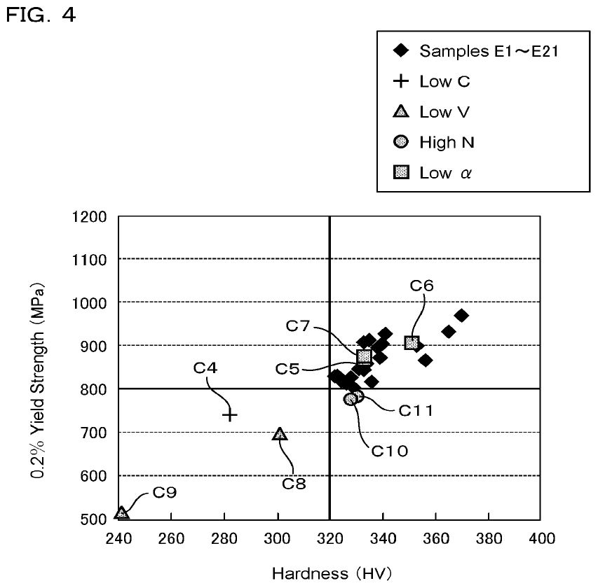

In FIG. 4, the horizontal axis indicates the hardness (HV), and the vertical axis indicates the 0.2% yield strength (MPa) and the results of samples E1 through E21, samples C4 which C-content ratio was low, samples C8 and C9 which V-content ratio was low, samples C10 and C11 which N-content ratio was high and samples C5 through C7 which ferrite area ratio was low were plotted. As shown in FIG. 4, it is important to at least control the chemical component composition to be in the proper range to improve both hardness and 0.2% yield strength.

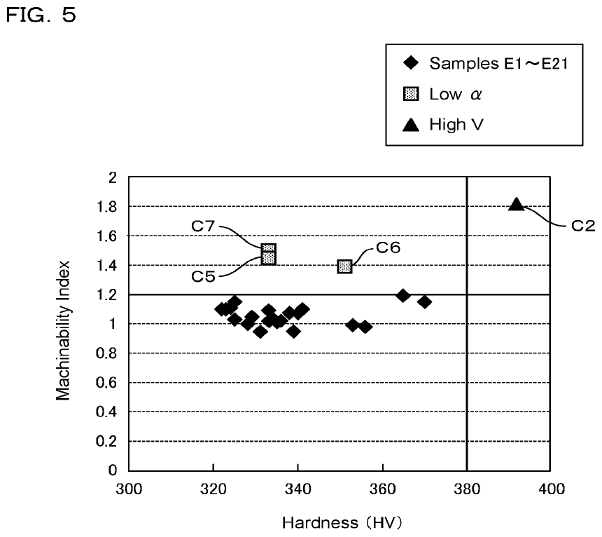

In FIG. 5, the horizontal axis indicates the hardness (HV), and the vertical axis indicates the machinability index and the results of the samples E1 through E21, sample C2 which V content ratio was high and the samples C5 through C7 which ferrite area ratio was low were plotted. As shown in FIG. 5, the machinability may worsen when the ferrite area ratio is low, and the hardness exceeds the value of 380 HV.

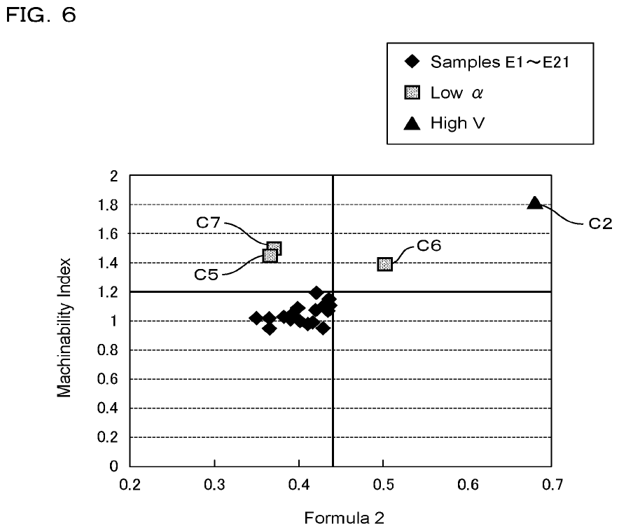

In FIG. 6, the horizontal axis indicates the values obtained by the formula 2, the vertical axis indicates the machinability index and the results of the samples E1 through E21, sample C2 which V content ratio was high and the samples C5 through C7 which ferrite area ratio was low were plotted. As shown in FIG. 6, the machinability can be secured when the formula 2 is satisfied and at the same time the value of ferrite area ratio is equal to or more than 30%, irrespective of the positive addition of Ca.

### Experimental Example 2

In this experimental example, the samples E14, E15, C10 and C11 were representatively selected from Table 1 and the influence of heating temperature during hot forging on various properties were analyzed. In detail, the strength evaluation test pieces and the machinability evaluation test pieces were tested under the various conditions of heating temperatures of 1200° C., 1230° C., and 1260° C. during hot forging. The other manufacturing conditions were the same with those in the experimental example 1. The various property evaluation methods were the same with those of the experimental example 1. The result of evaluation is indicated in Table 3 below.

TABLE 3

| | | | | Tensile | 0.2% Yield | | Ferrite | Charpy | Fracture | |
|---|---|---|---|---|---|---|---|---|---|---|
| Sample | | Hot Forging | Hardness | Strength | Strength | Yield | Area | Impact Value | Surface | |
| No. | N (%) | Temperature | HV | MPa | Mpa | Ratio | Ratio | J/cm² | Unevenness | Remarks |
| E14 | 0.0145 | 1200° C. | 327 | 1068 | 785 | 0.735 | 37% | 26.3 | 1.65 | Comparative |
| | | | | | | | | | | Example |
| | 0.0145 | 1230° C. | 329 | 1070 | 805 | 0.752 | 35% | 23.4 | 1.59 | Example |
| | 0.0145 | 1260° C. | 332 | 1075 | 821 | 0.764 | 34% | 21.5 | 1.55 | Example |
| E15 | 0.0120 | 1200° C. | 335 | 1092 | 788 | 0.722 | 43% | 20.8 | 1.58 | Comparative |
| | | | | | | | | | | Example |
| | 0.0120 | 1230° C. | 336 | 1092 | 817 | 0.748 | 45% | 17.2 | 1.52 | Example |
| | 0.0120 | 1260° C. | 338 | 1093 | 836 | 0.765 | 47% | 16.4 | 1.49 | Example |
| C10 | 0.0158 | 1200° C. | 327 | 1060 | 769 | 0.725 | 51% | 25.9 | 1.63 | Comparative |
| | | | | | | | | | | Example |
| | 0.0158 | 1230° C. | 328 | 1065 | 778 | 0.731 | 50% | 21.1 | 1.58 | Comparative |
| | | | | | | | | | | Example |
| | 0.0158 | 1260° C. | 330 | 1071 | 792 | 0.739 | 48% | 19.1 | 1.56 | Comparative |
| | | | | | | | | | | Example |
| C11 | 0.0165 | 1200° C. | 327 | 1058 | 771 | 0.729 | 45% | 26.1 | 1.62 | Comparative |
| | | | | | | | | | | Example |
| | 0.0165 | 1230° C. | 330 | 1060 | 784 | 0.740 | 41% | 22.8 | 1.56 | Comparative |
| | | | | | | | | | | Example |
| | 0.0165 | 1260° C. | 331 | 1064 | 795 | 0.747 | 39% | 21.1 | 1.54 | Comparative |
| | | | | | | | | | | Example |

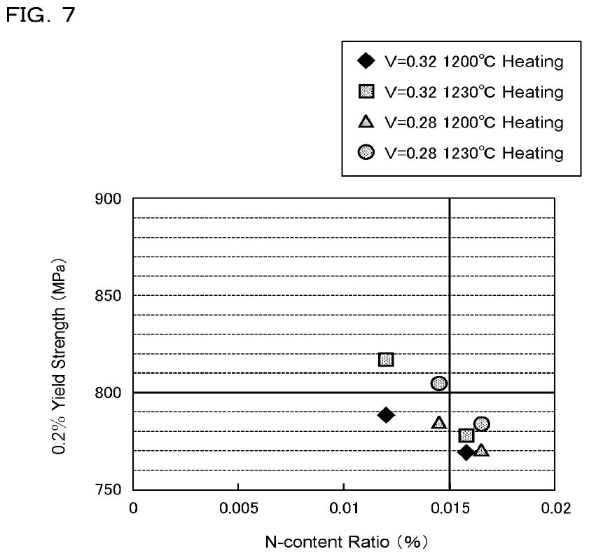

In FIG. 7, the horizontal axis indicates the N content ratio (%) and the vertical axis indicates the 0.2% yield strength (MPa) and the result indicated in Table 3 was plotted when the hot forging temperature was 1200° C. and 1230° C. As shown in Table 3 and FIG. 7, at least when the N content ratio is 0.015% or less, it is possible to secure the value of 800 MPa or more for the 0.2% yield strength at the hot forging temperature of 1230° C. or more. However, when the N content ratio exceeds 0.015%, it is impossible to secure the value of 800 MPa or more for the 0.2% yield strength even setting the hot forging temperature at 1230° C. or 1260° C.

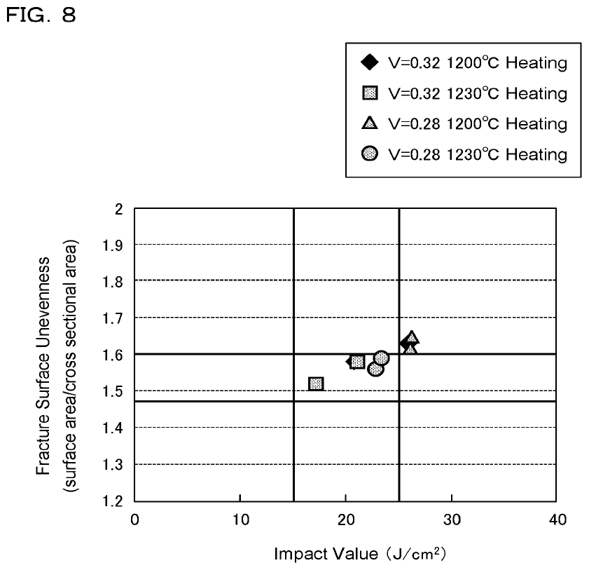

In FIG. 8, the horizontal axis indicates the Charpy impact value (J/cm²), and the vertical axis indicates the fracture surface unevenness. The result of the test under the hot forging temperature of 1200° C. and 1230° C. was plotted. As shown in Table 3 and FIG. 8, setting the hot forging temperature to 1230° C. or more is a necessary condition to set at least the Charpy impact value and the fracture surface unevenness to be in the respective proper range.

### Experimental Example 3

In this experimental example, an experiment was conducted, by which more detail influence of the cooling speed after hot forging on the samples was figured out. Concretely, the sample E1 was selected from the samples in the Table 1 as a representative sample and the cooling level of fan for fan cooling during the cooling process at the hot forging was adjusted when the strength evaluation test piece and the machinability evaluation test piece were manufactured. The condition of the average cooling speed was set to be either 100° C./min., 190° C./min., or 300° C./min at the temperature between 800° C. and 600° C., and other conditions were set same to those of the experimental example 1. The various property evaluation methods were the same with those of the experimental example 1. The result of evaluation is indicated in Table 4.

TABLE 4

| | | | Tensile | 0.2%Yield | | | Charpy | | Fracture | |
|---|---|---|---|---|---|---|---|---|---|---|
| Sample | Cooling | Hardness | Strength | Strength | Yield | Ferrite | Impact Value | Machinability | Surface | |
| No. | Speed | HV | MPa | MPa | Ratio | Area Ratio | J/cm² | Index | Unevenness | Remarks |
| E1 | 100° C./min | 290 | 972 | 748 | 0.770 | 62% | 25.8 | 1.03 | 1.62 | Comparative |
| | | | | | | | | | | Example |
| | 190° C./min | 324 | 1033 | 820 | 0.794 | 52% | 18.7 | 1.11 | 1.54 | Example |
| | 300° C./min | 338 | 1138 | 802 | 0.705 | 0% | 14.3 | 1.24 | 1.42 | Comparative |
| | | | | | | (Bainite) | | | | Example |

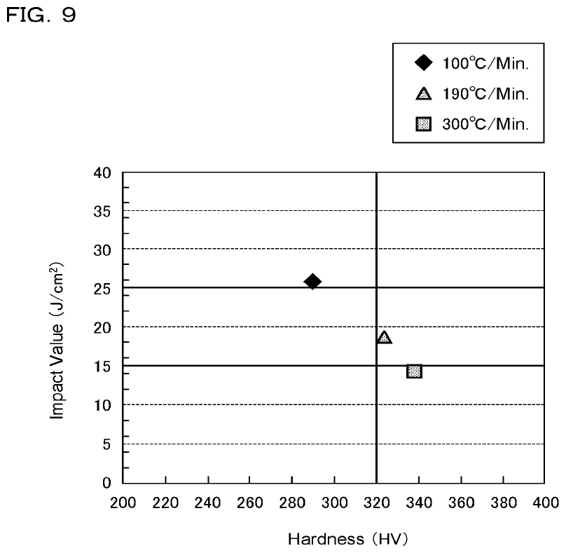

In FIG. 9, the horizontal axis indicates the hardness (HV), and the vertical axis indicates the Charpy impact value (J/cm²), and all the results shown in Table 4 were plotted.

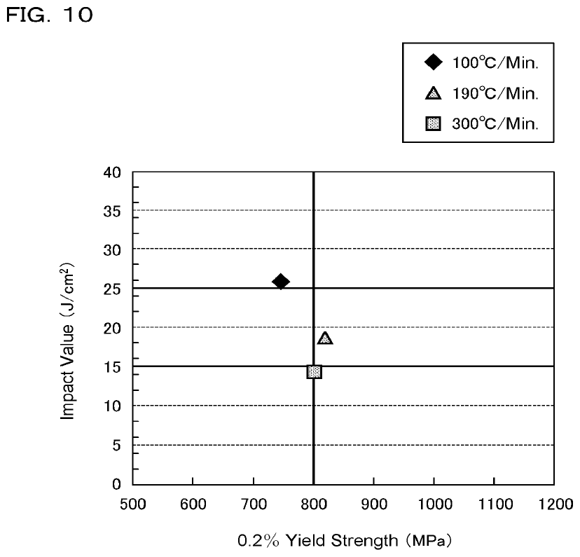

In FIG. 10, the horizontal axis indicates 0.2% yield strength (MPa), and the vertical axis indicates the Charpy impact value (J/cm²), and all the results shown in Table 4 were plotted.

As apparent from Table 4, FIG. 9 and FIG. 10, every property was found to be acceptable by setting the cooling speed in the range of 800 to 600° C. to 190° C./min which falls in the proper range of 150 to 250° C./min.

On the other hand, when the cooling speed was set to 100° C./min, the values of the hardness and 0.2% yield strength became too low and the Charpy impact value and the fracture surface unevenness became too high. Further, when the cooling speed was set to 300° C./min, the bainite structure was produced which prevents forming of proper metal structure and as a result, respective intended values of all Charpy impact value, machinability, and fracture surface unevenness properties could not be achieved.

### (Influence of Fracture Surface Unevenness)

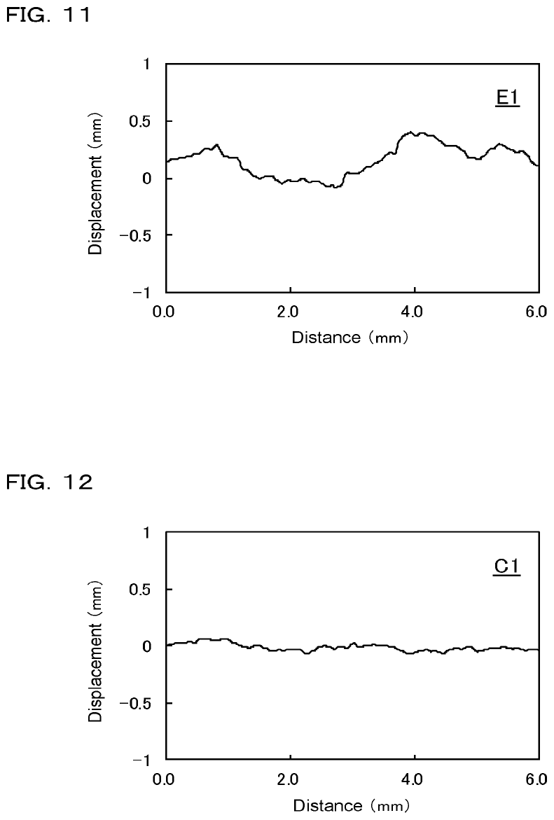

FIGS. 11 and 12 indicate the diagrammatized unevenness on randomly taken straight line of the fracture surface, based on the information obtained from the samples E1 and C1 in Experimental Example 1 when the fracture surface unevenness of the Charpy impact test piece was measured. FIG. 11 indicates the unevenness shape of the fracture surface of the sample E1, whereas FIG. 12 indicates the unevenness shape of the fracture surface of the sample C1. In both figures, the horizontal axis indicates the distance (mm) on the randomly taken straight line and the vertical axis indicates the displacement (mm) of the unevenness. As shown in Table 2 explained above, the value of sample E1 fracture surface unevenness (surface area/cross sectional area) is 1.54 and the value of sample C1 fracture surface unevenness is 1.39.

As understood from FIGS. 11 and 12, the sample E1, which value of fracture surface unevenness (surface area/cross sectional area) was in the range of 1.47 to 1.60, has a proper amplitude in unevenness, but the sample C1, which value of fracture surface unevenness (surface area/cross sectional area) was less than 1.47, has a smaller amplitude, more like flat in unevenness.

As understood from the difference in shape, when the fracture surface unevenness has a proper amplitude, even a small deviation of position at the fracture-split surface upon re-contacting positioning may lead to generation of a relatively large gap, by which deviation can be confirmed immediately, and thus, a positioning at a proper position can be always achieved. On the other hand, if the amplitude of fracture surface unevenness is small and is like a flat surface, a slight deviation at the fracture-split surface upon re-positioning thereof may not be noticeable and no unusual feeling on outer appearance can be noticed, therefore, there is a risk that such abnormality may not be exposed at the assembling step.

As explained above, in the case where the fracture surface unevenness (surface area/cross sectional area) exceeds 1.60, although the amplitude of the fracture surface unevenness becomes larger than that of the sample E1, exceeding of 1.60 tends to become a cause of a high Charpy impact value and eventually may cause a too large deformation upon fracture-splitting, as apparent from FIG. 2. Therefore, it is necessary to control the fracture surface unevenness (surface area/cross sectional area) not to exceed 1.60.

As described above, it is highly effective to control the fracture surface unevenness (surface area/cross sectional area) to be in the range of 1.47 to 1.60, for a product which is made by re-contacting split parts, after fracture-splitting, such as for example, a connecting rod manufactured by fracture-splitting method.

As the results explained above, it is not sufficient for securing the superior properties, such as yield strength, keeping controlling the fracture surface unevenness to be in the range defined above, to adjust the individual components to be in the range defined above, such as to have the P-content ratio to be 0.030% or less. It has also to optimize the components to satisfy the formulae 1 through 3 (it is important for the fracture surface unevenness to satisfy, particularly, the formula 1) and in addition to do thus, it is particularly important to manufacture the component under the proper forging conditions (such as, hot forging temperature, cooling speed after forging). It is noted that based on the above knowledge obtained by the invention, the inventors applied the present invention to a practically used connecting rod component and confirmed that the assembling after fracture-splitting was satisfactory when the value of fracture surface unevenness of the Charpy impact test for the hot forging component satisfied the condition defined by the present invention.

1. A forged component having a chemical composition comprising, by mass %, C: 0.30 to 0.45%, Si: 0.05 to 0.35%, Mn: 0.50 to 0.90%, P: 0.030% or less, S: 0.040 to 0.070%, Cr: 0.01 to 0.50%, Al: 0.001 to 0.050%, V: 0.25 to 0.35%, Ca: 0 to 0.0100%, N: 0.0150% or less, and the balance being Fe and unavoidable impurities, and satisfying the following formulae 1, 2 and 3:
24<8×[C]+7×[Si]+10×[Mn]+220×[P]+45×[V]<33 Formula 1:
[C]−4×[S]+[V]−25×[Ca]<0.44, and Formula 2:
2.15≤4×[C]−[Si]+(⅕)×[Mn]+7×[Cr]−[V]≤2.61 Formula 3:
(wherein [X] in the Formulae 1 through 3 means a value of ratio of the content (mass %) of an element X), wherein
metal structure is a ferrite pearlite structure, and a ferrite area ratio is 30% or more;
Vickers hardness is in the range of 320 to 380 HV;
0.2% yield strength is 800 MPa or more;
a Charpy V-notch impact value is in the range of 15 to 25 J/cm²; and
an unevenness of fracture surface (surface area/cross sectional area) of a Charpy test piece after fracture is in the range of 1.47 to 1.60.

2. A connecting rod comprising the forged component according to claim 1.

3. A method for manufacturing the forged component according to claim 1, comprising:
a step of subjecting a steel material having the chemical composition to hot forging at a hot forging temperature of 1230° C. to 1300° C. to obtain the forged component; and
a step of cooling the forged component so that an average cooling speed from 800 to 600° C. is 150 to 250° C./min.
